(19) United States
(12) Patent Application Publication
(10) Pub. No.: US 2006/0251844 A1
(43) Pub. Date: Nov. 9, 2006

(54) Polarizer assembly, method of manufacturing the same and method of manufacturing panel assembly having the same

(76) Inventors: Sang-Gun Choi, Suwon-si (KR); Hyang-Shik Kong, Cheonan-si (KR); Jae-Ho Lee, Seoul (KR); Kweon-Sam Hong, Seoul (KR); Hyun-Duck Son, Suwon-si (KR); Hee-Wook Do, Suwon-si (KR); Yoon-Sung Um, Yongin-si (KR); Dong-Hoon Chung, Suwon-si (KR); Hak-Sun Chang, Yongin-si (KR); Seung-Hoo Yoo, Seongnam-si (KR); Hyun-Wuk Km, Yongin-si (KR)

Correspondence Address: F. CHAU & ASSOCIATES, LLC, 130 WOODBURY ROAD, WOODBURY, NY, 11797, US

(21) Appl. No.: 11/417,016

(22) Filed: May 3, 2006

(30) Foreign Application Priority Data
May 4, 2005 (KR) 2005-37529
Jul. 21, 2005 (KR) 2005-66191

(51) Int. Cl. B32B 33/00

(52) U.S. Cl. 428/40.1

(57) ABSTRACT

A polarizer assembly is provided. The polarizer assembly includes a polarizer, an adhesive layer on the polarizer, an adhesive layer protecting film that is attached to the adhesive layer and an antistatic member that absorbs an electrostatic charge generated during detachment of the adhesive layer protecting film from the adhesive layer.

### CROSS REFERENCE OF RELATED APPLICATIONS

The present application claims priority from Korean Patent Application No. 2005-37529, filed on May 4, 2005, and Korean Patent Application No. 2005-66191, filed on Jul. 21, 2005, the disclosures of which are hereby incorporated by reference herein in their entireties.

### BACKGROUND OF THE INVENTION

1. Field of the Invention

The present invention relates to a polarizer assembly. More particularly, the present invention relates to a polarizer assembly capable of decreasing an electrostatic charge, a method of manufacturing the polarizer assembly and a method of manufacturing a panel assembly having the polarizer assembly.

2. Description of the Related Art

Information processing devices have various shapes and functions. The information outputted from these processing devices are processed as electric signals. A display device then converts these electric signals into an image so that a user may perceive this information.

An example of a display device is a liquid crystal display (LCD) device that displays an image using liquid crystals. An LCD device has characteristics such as being thin, light weight, having low power consumption and low driving voltage.

An LCD device includes an LCD panel and a backlight assembly. The LCD panel displays the image using the light transmittance of liquid crystals. The backlight assembly is located underneath the LCD panel for supplying the LCD panel with light. The light supplied from the backlight assembly to the LCD panel is typically non-polarized light.

However, since the light transmittance of the liquid crystals of the LCD panel is changed by birefringence of the liquid crystals, the LCD panel requires polarized light. In this regard, to polarize the light generated from the backlight assembly, the LCD device further includes a polarizer assembly.

A polarizer assembly can include a polarizer, an adhesive layer located on the polarizer, an adhesive layer protecting film located on the adhesive layer and a polarizer protecting film located underneath the polarizer. To attach the polarizer assembly to the LCD panel, the adhesive layer protecting film is removed from the polarizer assembly, and the adhesive layer is attached to the LCD panel.

However, when the adhesive layer protecting film is removed from the polarizer assembly, an electrostatic charge is stored in the polarizer assembly. Consequently, when the polarizer assembly is attached to the LCD panel, the electrostatic charge that is stored in the polarizer assembly is then also applied to the LCD panel causing a spot to be formed on the LCD panel, and thereby also causing the image display quality of the LCD panel to deteriorate.

Thus, there is a need for a polarizer assembly which when attached to an LCD panel does not cause the image display quality of the display device to deteriorate. In particular, there is a need for a polarizer assembly which when attached to an LCD panel does not result in an electrostatic charge being applied to the LCD panel.

### SUMMARY OF THE INVENTION

According to an exemplary embodiment of the present invention, a polarizer assembly is provided. The polarizer assembly includes a polarizer, an adhesive layer on the polarizer, an adhesive layer protecting film that is attached to the adhesive layer and an antistatic member that absorbs an electrostatic charge generated during detachment of the adhesive layer protecting film from the adhesive layer.

According to another exemplary embodiment of the present invention, a method of manufacturing a polarizer assembly is provided. The method comprises forming a polarizer, forming an adhesive layer on the polarizer, forming an antistatic member operatively coupled to the polarizer, and attaching an adhesive layer protecting film to the adhesive layer. The antistatic member is for absorbing an electrostatic charge generated during a detachment of the adhesive layer protecting film from the adhesive layer.

According to another exemplary embodiment of the invention, a polarizer assembly is provided. The method includes providing a polarizer assembly which includes a polarizer, an adhesive layer on the polarizer, an adhesive layer protecting film that is attached to the adhesive layer, and an antistatic member that absorbs an electrostatic charge generated during detachment of the adhesive layer protecting film from the adhesive layer. The method further includes removing the adhesive layer protecting film from the polarizer assembly, aligning the polarizer assembly without the adhesive layer protecting film on a display panel, and attaching the polarizer assembly without the adhesive layer protecting film to the display panel.

### BRIEF DESCRIPTION OF THE DRAWINGS

FIG. 1 is a perspective view showing a polarizer assembly in accordance with an exemplary embodiment of the present invention;

FIG. 2 is a cross-sectional view taken along a line I-I′ shown in FIG. 1;

FIG. 3 is a cross-sectional view showing a polarizer assembly in accordance with an exemplary embodiment of the present invention;

FIG. 4 is a cross-sectional view showing a polarizer assembly in accordance with an exemplary embodiment of the present invention;

FIG. 5 is a perspective view showing a polarizer assembly in accordance with an exemplary embodiment of the present invention;

FIG. 6 is a cross-sectional view taken along a line II-II′ shown in FIG. 5;

FIG. 7 is a cross-sectional view showing a polarizer assembly in accordance with an exemplary embodiment of the present invention;

FIGS. 8A to 8D are cross-sectional views showing a method of manufacturing a polarizer assembly in accordance with an exemplary embodiment of the present invention;

FIGS. 9A and 9B are cross-sectional views showing a method of manufacturing a panel assembly in accordance with an exemplary embodiment of the present invention;

FIG. 10 is a flow chart showing a method of manufacturing a display device in accordance with an exemplary embodiment of the present invention;

FIG. 11A is a cross-sectional view showing a display device manufactured by the method shown in FIG. 10; and

FIG. 11B is a cross-sectional view showing an LCD device manufactured by the method in accordance with an exemplary embodiment of the present invention.

### DESCRIPTION OF THE EXEMPLARY EMBODIMENTS OF THE INVENTION

The invention is described more fully hereinafter with reference to the accompanying drawings, in which embodiments of the invention are shown. This invention may, however, be embodied in many different forms and should not be construed as limited to the embodiments set forth herein.

Hereinafter, the exemplary embodiments of the present invention will be described in detail with reference to the accompanying drawings.

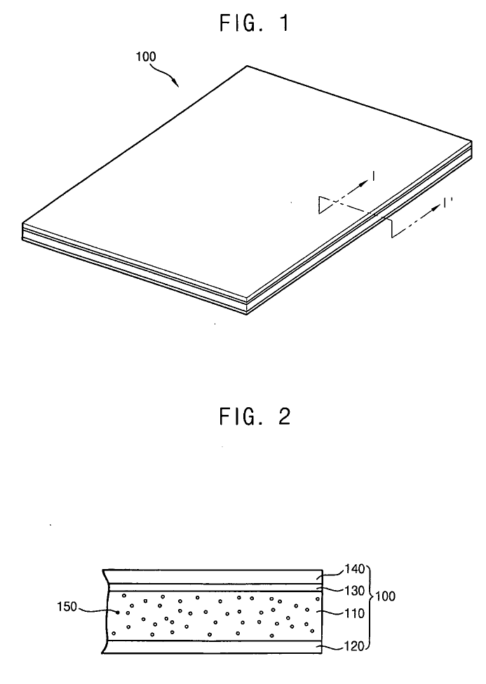

FIG. 1 is a perspective view showing a polarizer assembly in accordance with an exemplary embodiment of the present invention. FIG. 2 is a cross-sectional view taken along a line I-I′ shown in FIG. 1.

Referring to FIGS. 1 and 2, the polarizer assembly 100 includes a polarizer 110, a polarizer protecting film 120, an adhesive layer 130, an adhesive layer protecting film 140 and an antistatic member 150.

The polarizer 110 has a plate shape, and polarizes an externally provided non-polarized light into a polarized light. That is, non-polarized light which vibrates in various directions is polarized by the polarizer 110, such that the polarized light vibrates in a polarization axis and then passes through the polarizer 110.

For example, the polarizer 110 includes polyvinylalcohol (PVA) and a dichromatic material. Examples of the dichromatic material that can be used for the polarizer 110 include but are not limited to iodine (I₂) and chlorine (Cl₂). The arrangement and size of the dichromatic material determine the polarization axis of the polarizer 110. For example, the thickness of the polarizer 110 may be about 200 μm.

In addition, a waterproof thin film may be coated on the polarizer 110 to protect the polarizer 110 from moisture.

The polarizer protecting film 120 is on a surface of the polarizer 110 to protect the polarizer 110 from scratches or pollutants which may cause damage to the polarizer 110. The polarizer protecting film 120 includes a transparent synthetic resin. Examples of the transparent synthetic resin that can be used for the polarizer protecting film 120 include but are not limited to a polyvinyl (PV) film, a low density polyester film, or a polyethyleneterephthalate film. The polarizer protecting film 120 may have a thinner thickness than the polarizer 110.

In this exemplary embodiment, the adhesive layer 130 is on a side of the polarizer 110 opposite to the polarizer protecting film 120. The adhesive layer 130 may comprise a urea based resin. For example, the adhesive layer 130 includes a pressure sensitive adhesive (PSV) that has various characteristics such as high adhesive strength, high heat resistance, and also waterproof. The polarizer 110 is attached to a surface of a display panel through the adhesive layer 130. The thickness of the adhesive layer 130 may be about 15 μm.

The adhesive layer protecting film 140 is on the adhesive layer 130 to protect the adhesive layer 130, thereby maintaining the adhesive strength of the adhesive layer 130. In addition, the adhesive layer protecting film 140 has a transparent material to check for particles between the polarizer 110 and the adhesive layer 130 and between the adhesive layer 130 and the adhesive layer protecting film 140.

When attaching the polarizer 110 to the display panel, the adhesive layer protecting film 140 is removed from the polarizer assembly 100, and then the polarizer 110 is attached to the display panel through the adhesive layer 130. The adhesive layer protecting film 140 includes a synthetic resin that may be easily detached from the adhesive layer 130.

The antistatic member 150 includes a plurality of conductive particles. The conductive particles may be randomly distributed in the polarizer 110. Hereinafter, a reference numeral 150 represents the conductive particles.

The conductive particles 150 include a conductive polymer. Examples of the conductive polymers that can be used for the conductive particles 150 include but are not limited to polypyrrole, polythiophene, or polyaniline. The conductive particles 150 are uniformly distributed in the polarizer 110 to absorb electric charges generated during the detaching of the adhesive layer protecting film 140 from the adhesive layer 130. Therefore, the conductive particles 150 decrease the amount of electric charges that may be applied to the display panel.

Furthermore, the density of the conductive particles 150 determines the amount of the electrostatic charge that may be applied to the display panel. For example, when the density of the conductive particles 150 is increased, the amount of the electrostatic charge that may be applied to the display panel is decreased. However, when the density of the conductive particles 150 is increased, the light transmittance of the polarizer 110 is decreased. Therefore, the density of the conductive particles 150 is adjusted to maintain the light transmittance of the polarizer 110.

According to the polarizer assembly 100 shown in FIGS. 1 and 2, the conductive particles 150 are in the polarizer 110 to absorb the electrostatic charge that is generated during the detaching of the adhesive layer protecting film 140 from the adhesive layer 130.

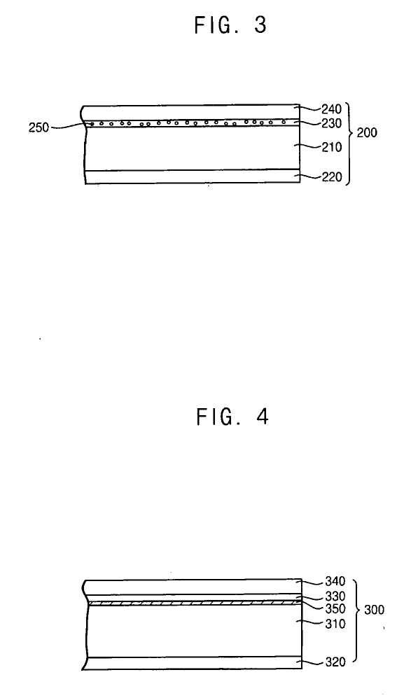

FIG. 3 is a cross-sectional view showing a polarizer assembly in accordance with an exemplary embodiment of the present invention.

Referring to FIG. 3, the polarizer assembly 200 includes a polarizer 210, a polarizer protecting film 220, an adhesive layer 230, an adhesive layer protecting film 240 and an antistatic member 250.

The polarizer 210 has a plate shape, and polarizes an externally provided non-polarized light into a polarized light. That is, non-polarized light which vibrates in various directions is polarized by the polarizer 210, such that the polarized light vibrates in a polarization axis and then passes through the polarizer 210.

The polarizer protecting film 220 is on a surface of the polarizer 210 to protect the polarizer 210.

The adhesive layer 230 in this exemplary embodiment is on a side of the polarizer 210 opposite to the polarizer protecting film 220. The thickness of the adhesive layer 230 may be about 15 μm.

The adhesive layer protecting film 240 is on the adhesive layer 230 to protect the adhesive layer 230, thereby maintaining the adhesive strength of the adhesive layer 230.

The antistatic member 250 includes a plurality of conductive particles. The conductive particles may be randomly distributed in the adhesive layer 230. Hereinafter, a reference numeral 250 represents the conductive particles.

The conductive particles 250 include a conductive polymer. Examples of the conductive polymers that can be used for the conductive particles 250 include but are not limited to polypyrrole, polythiophene, or polyaniline. The conductive particles 250 are uniformly distributed in the adhesive layer 230 to absorb an electric charge that is generated during the detaching of the adhesive layer protecting film 240 from the adhesive layer 230. Thus, the conductive particles decrease the amount of electric charges that may be applied to the display panel.

The density of the conductive particles 250 determines the amount of the electrostatic charge that may be applied to the display panel. When the density of the conductive particles 250 is increased, the amount of the electrostatic charge that may be applied to the display panel is decreased. However, when the density of the conductive particles 250 is increased, the light transmittance of the polarizer assembly 200 is decreased. Therefore, the density of the conductive particles 250 is adjusted to maintain the light transmittance of the polarizer assembly 200.

According to the polarizer assembly 200 shown in FIG. 3, the conductive particles 250 are in the adhesive layer 230 to absorb the electrostatic charges generated during the detaching of the adhesive layer protecting film 240 from the adhesive layer 230.

FIG. 4 is a cross-sectional view showing a polarizer assembly in accordance with an exemplary embodiment of the present invention.

Referring to FIG. 4, the polarizer assembly 300 includes a polarizer 310, a polarizer protecting film 320, an adhesive layer 330, an adhesive layer protecting film 340 and an antistatic member 350.

The polarizer 310 has a plate shape, and polarizes an externally provided non-polarized light into a polarized light. That is, non-polarized light which vibrates in various directions is polarized by the polarizer 310, such that the polarized light vibrates in a polarization axis and then passes through the polarizer 310.

The polarizer protecting film 320 is on a surface of the polarizer 310 to protect the polarizer 310.

The adhesive layer 330 is on a side of the polarizer 310 opposite to the protecting film 320.

The adhesive layer protecting film 340 is on the adhesive layer 330 to protect the adhesive layer 330, thereby maintaining the adhesive strength of the adhesive layer 330.

The antistatic member 350 includes an antistatic layer between the polarizer 310 and the adhesive layer 330. Hereinafter, a reference numeral 350 represents the antistatic layer.

The antistatic layer 350 includes but is not limited to an organic material, a surfactant, or a conductive material. Examples of the conductive material that can be used for the antistatic layer 350 includes but is not limited to a metal or a metal compound such as copper, aluminum, silver, indium tin oxide (ITO), antimony tin oxide (ATO), or a conductive polymer such as polypyrrole, polythiophene, or polyaniline. The polypyrrole, polythiophene and polyaniline are conductive polymers. The antistatic layer 350 absorbs electric charges that are generated during the detaching of the adhesive layer protecting film 340 from the adhesive layer 330, thereby decreasing the amount of electrical charges which may be applied to the display panel.

The thickness of the antistatic layer 350 is adjusted so that light may pass through the antistatic layer 350. For example, the thickness of the antistatic layer 350 is about 50 \acute{Å} to about 500 \acute{Å}. The thickness of the antistatic layer 350 may be about 100 \acute{Å} to about 200 \acute{Å}.

According to the polarizer assembly 300 shown in FIG. 4, the antistatic layer 350 is between the polarizer 310 and the adhesive layer 330 to absorb the electrostatic charge that is generated during the detaching of the adhesive layer protecting film 340 from the adhesive layer 330.

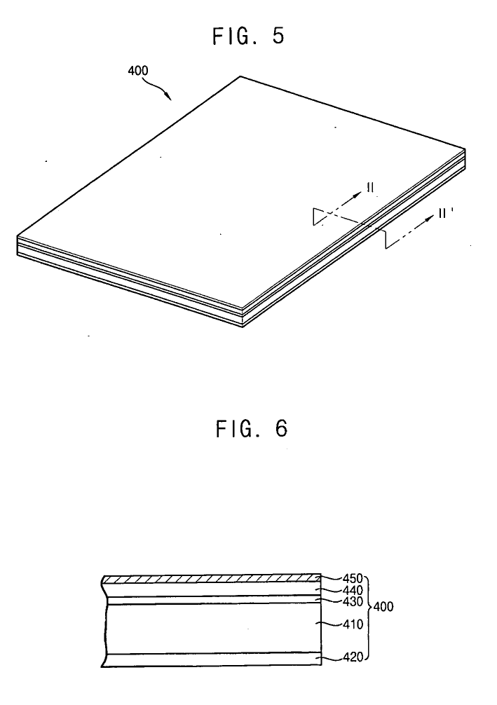

FIG. 5 is a perspective view showing a polarizer assembly in accordance with an exemplary embodiment of the present invention. FIG. 6 is a cross-sectional view taken along a line II-II′ shown in FIG. 5.

Referring to FIGS. 5 and 6, the polarizer assembly 400 includes a polarizer 410, a polarizer protecting film 420, an adhesive layer 430, an adhesive layer protecting film 440 and an antistatic member 450.

The polarizer 410 has a plate shape, and polarizes an externally provided non-polarized light into a polarized light. That is, non-polarized light which vibrates in various directions is polarized by the polarizer 410, such that the polarized light vibrates in a polarization axis and then passes through the polarizer 410.

The polarizer protecting film 420 is on a surface of the polarizer 410 to protect the polarizer 410.

The adhesive layer 430 is on a side of the polarizer 410 opposite to the polarizer protecting film 420.

The adhesive layer protecting film 440 is on the adhesive layer 430 to protect the adhesive layer 430, thereby maintaining the adhesive strength of the adhesive layer 430.

The antistatic member 450 includes an antistatic layer on the adhesive layer protecting film 440. Hereinafter, a reference numeral 450 represents the antistatic layer.

The antistatic layer 450 is located opposite to the adhesive layer 430 so that the adhesive layer 430 may not be bent.

The antistatic layer 450 includes but is not limited to an organic material, a surfactant, or a conductive material. Examples of the conductive material that can be used for the antistatic layer 450 may include but is not limited to a metal or a metal compound such as copper, aluminum, silver, indium tin oxide (ITO), or antimony tin oxide (ATO), or a conductive polymer such as polypyrrole, polythiophene, or polyaniline.

The antistatic layer 450 absorbs an electric charge that is generated during the detaching of the adhesive layer protecting film 440 from the adhesive layer 430, thereby decreasing the amount of electric charge that may be applied to the display panel.

According to the polarizer assembly 400 shown in FIGS. 5 and 6, the antistatic layer 450 is on the adhesive layer protecting film 440 to absorb the electrostatic charge that is generated during the detaching of the adhesive layer protecting film 440 from the adhesive layer 430.

In addition, when the adhesive layer protecting film 440 is detached from the adhesive layer 430, the antistatic layer 450 is removed with the adhesive layer protecting film 440 so that the light transmittance of the polarizer assembly 400 is improved.

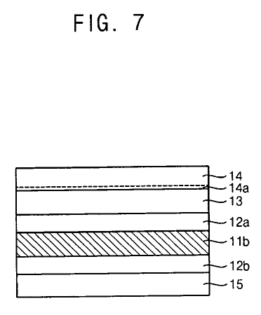

FIG. 7 is a cross-sectional view showing a polarizer assembly in accordance with an exemplary embodiment of the present invention.

Referring to FIG. 7, the polarizer assembly includes a polarizer, a surface treated layer 13 and a polarizer protecting film 14.

The polarizer includes a polarizing film 11 and a plurality of supporting films 12a and 12b. The polarizing film 11 polarizes an externally provided non-polarized light into a polarized light. The supporting films 12a and 12b are on both surfaces of the polarizing film 11 to support the polarizing film 11.

For example, a dichromatic colorant is adsorbed onto a polyvinyl alcohol (PVA) that is extended in a polarizing axis to form the polarizing film 11. Examples of the dichromatic colorant that can be used for the polarizing film 11 include but are not limited to iodine or chlorine. A non-polarized light that vibrates in various directions is polarized by the polarizing film 11 so that the polarized light vibrates in the polarization axis and then passes through the polarizing film 11. The supporting films 12a and 12b may include triacetate cellulose (TAC), and protect the polarizing film 11 from mechanical stress and chemical pollution such as heat, impact, and moisture.

The polarizer protecting film 14 is on the surface treated layer 13. That is, the polarizer protecting film 14 forms an outmost layer of the polarizer assembly. Further, in this exemplary embodiment, the polarizer assembly is attached to the LCD panel, and the polarizer protecting film 14 is opposite to the LCD panel. The polarizer protecting film 14 protects the polarizer from mechanical stress and chemical pollution. Synthetic resins that can be used for the polarizer protecting film 14 include but are not limited to polyester or polypropylene.

An antistatic treatment is performed on an exterior surface of the polarizer protecting film 14. For example, an antistatic layer is formed on the polarizer protecting film 14. The antistatic layer absorbs an electrostatic charge that is generated during the detaching of the polarizer protecting film from the polarizer assembly. In particular, after attaching the polarizer assembly to the LCD panel, the polarizer protecting film 14 is detached from the polarizer assembly. When the polarizer protecting film 14 is detached from the polarizer assembly, an electrostatic charge is generated so that a spot may be formed on the LCD panel, thereby deteriorating the image display quality of the LCD panel. The antistatic layer absorbs the electrostatic charge to protect the LCD panel.

An adhesive layer 14a may be formed on the polarizer protecting film 14. For example, an adhesive is coated on the polarizer protecting film 14 to form the adhesive layer 14a. When the polarizer protecting film 14 is detached from the polarizer assembly, the adhesive layer 14a is also removed with the polarizer protecting film 14. The antistatic treatment may be performed on the polarizer protecting film 14 or the adhesive layer 14a.

The surface treated film 13 is between the polarizer protecting film 14 and one of the supporting films 12a and 12b. For example, the surface treated film 13 may be between the polarizer protecting film 14 and an upper supporting film 12a of the supporting films 12a and 12b. Moreover, the surface treated film 13 is attached to the polarizer to perform an additional function. Examples of treatments that can be performed on the surface treated film 13 include but are not limited to an anti-glare treatment, or an anti-reflection treatment.

A compensation film 15 may be on a lower supporting film 12b of the supporting films 12a and 12b. The compensation film 15 improves the viewing angle of the LCD panel. The viewing angle is an angle with respect to a normal line of a front surface of the LCD panel that has a contrast ratio of about 1:10. A phase difference is changed with respect to the viewing angle, and the compensation film 15 compensates for a change in the phase difference to improve the viewing angle.

The polarizer assembly may further include an adhesing layer and an adhesing layer protecting film. The polarizer is attached to the LCD panel through the adhesing layer. The adhesing layer protecting film protects the adhesing layer from the mechanical stress and chemical pollution. The adhesing layer and the adhesing layer protecting film are located opposite to the plarizer protecting film 14. Alternatively, the compensation film 15 may be omitted, and the adhesing layer and the adhesing layer protecting film may be directly formed on the polarizer.

Table 1 shows a relationship between surface resistance and defective proportion. The antistatic treatment is performed on the polarizer protecting film 14 of Example Nos. 2 and 3, but the antistatic treatment is not performed on the polarizing protecting film of Example No. 1.

TABLE 1

| | | Example Number | | |
|---|---|---|---|---|
| | | 1 | 2 | 3 |
| Surface Resistance (Ω/sq) | | | 10⁹ | 10⁸ |
| Static Charge (kV) | | 11.99 | 0.69 | 0.11 |
| Defective Proportion | Material | 1% | 0.7% | 0.5% |
| by Particles | Process | 1% | 0.6% | 0.2% |

| | | | |
|---|---|---|---|
| Defective Proportion by | 6˜8% | 2˜3% | No more |
| Electrostatic Charge | | | than 0.5% |

The defective proportion corresponds to unit pilot plant that is arranged to manufacture a plurality of the LCD devices.

Referring to Table 1, when the antistatic treatment is not performed on the polarizing protecting film, the electrostatic charge that is generated during the detaching of the polarizer protecting film from the polarizer assembly is about 11.99 kV. In addition, the defective proportion by the particles of the material and the defective proportion by the particles provided during manufacturing processes are about 1% and about 1%, respectively. Furthermore, the defective proportion by an electrostatic charge is about 6% to about 8%.

When the antistatic treatment is performed on the polarizing protecting film so that the surface resistance is about 10⁹ Ω/sq, the electrostatic charge that is generated during the detaching of the polarizer protecting film from the polarizer assembly is about 0.69 kV. In addition, the defective proportion by the particles of the material and the defective proportion by the particles provided during manufacturing processes are about 0.7% and about 0.6%, respectively. Furthermore, the defective proportion by an electrostatic charge is about 2% to about 3%.

When the antistatic treatment is performed on the polarizing protecting film using the organic material or the surfactant, the surface resistance may be about 10⁹ to about 10¹² Ω/sq.

When the antistatic treatment is performed on the polarizing protecting film so that the surface resistance is about 10⁸ Ω/sq, the electrostatic charge that is generated during the detaching of the polarizer protecting film from the polarizer assembly is about 0.11 kV. In addition, the defective proportion by the particles of the material and the defective proportion by the particles provided during manufacturing processes are about 0.5% and about 0.2%, respectively. Furthermore, the defective proportion by an electrostatic charge is no more than about 0.5%.

When the metal or the conductive polymer is coated on the polarizing protecting film, the surface resistance may be no more than about 10⁸ Ω/sq.

That is, when the antistatic treatment is not performed on the polarizing protecting film, the electrostatic charge that is generated during the detaching of the polarizer protecting film from the polarizer assembly is about 11.99 kV. However, when the antistatic treatment is performed on the polarizing protecting film so that the surface resistance is about 10⁹ Ω/sq, the electrostatic charge that is generated during the detaching of the polarizer protecting film from the polarizer assembly is decreased to be about 0.69 kV. Furthermore, when the antistatic treatment is performed on the polarizing protecting film so that the surface resistance is about 10⁸ Ω/sq, the electrostatic charge that is generated during the detaching of the polarizer protecting film from the polarizer assembly is significantly decreased to be about 0.11 kV. Therefore, the defective proportion is also significantly decreased.

Particularly, the defective proportion by the particles of the material is decreased from about 2% to about 0.7%. That is, when the surface resistance is about 10⁸ Ω/sq, the defective proportion by the particles of the material is significantly decreased.

Furthermore, the defective proportion by the particles provided during manufacturing processes is decreased from about 6˜8% to no more than about 0.5%. That is, when the surface resistance is about 10⁸ Ω/sq, the defective proportion by the particles provided during manufacturing processes is significantly decreased.

In the above-mentioned examples, the electrostatic charge is generated during the detaching of the polarizer protecting film 14 shown in FIG. 7 from the polarizer assembly. The antistatic layers shown in FIGS. 1 to 6 thus also decrease the defective proportion of the LCD panel.

Therefore, when the surface resistance of the antistatic layers of FIGS. 1 to 7 is no more than about 10⁸ Ω/sq, the defective proportion of the LCD panel is significantly decreased.

Method of Manufacturing Polarizer Assembly

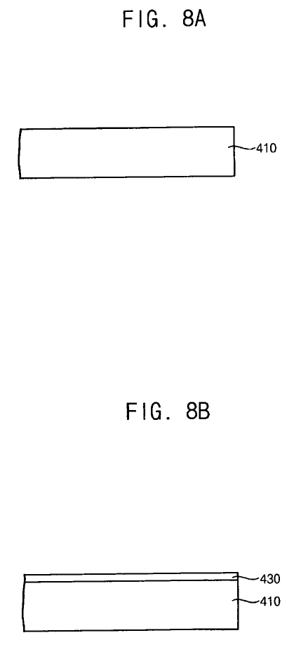

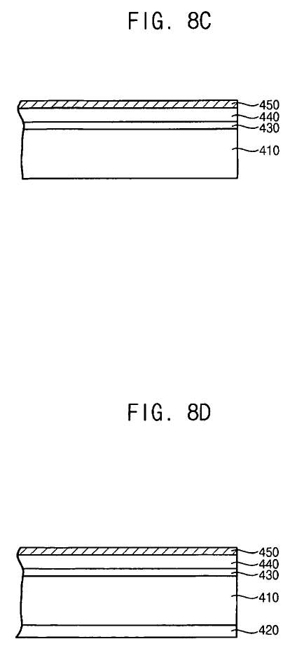

FIGS. 8A to 8D are cross-sectional views showing a method of manufacturing a polarizer assembly in accordance with an exemplary embodiment of the present invention.

As illustrated in FIG. 8A, when manufacturing the polarizer assembly, a polarizer 410 having a substantially plate shape is prepared. The polarizer 410 polarizes an externally provided non-polarized light into a polarized light. That is, non-polarized light which vibrates in various directions is polarized by the polarizer 410, such that the polarized light vibrates in a polarization axis and then passes through the polarizer 410.

Referring to FIG. 8B, an adhesive layer 430 is formed on one surface of the polarizer 410. The adhesive layer 430 may be formed of a urea resin that is coated on the surface of the polarizer 410. The adhesive layer 430 may be a pressure sensitive adhesive (PSA) that has various characteristics such as high adhesive strength, high heat resistance, and also waterproof.

Referring to FIG. 8C, an adhesive layer protecting film 440 that has an antistatic layer 450 is attached to the adhesive layer 430 to protect the adhesive layer 430, thereby maintaining the adhesive strength of the adhesive layer 430. Alternatively, an adhesive layer protecting film 440 may be attached to the adhesive layer 430, and then the antistatic layer 450 may be formed on the adhesive layer protecting film 440.

An organic material or a surfactant may be coated on the adhesive layer protecting film 440 to form the antistatic layer 450. In addition, a metal or a metal alloy may be deposited or plated on the adhesive layer protecting film 440 to form the antistatic layer 450. Furthermore, a conductive polymer solution may be coated on the adhesive layer protecting film 440 to form the antistatic layer 450. Indium tin oxide (ITO) or antimony tin oxide (ATO) may be dispersed in an alcohol solution, and coated on the adhesive layer protecting film 440 to form the antistatic layer 450. The temperature for forming the antistatic layer 450 is adjusted so that the adhesive layer protecting film 440 is not deformed. For example, the adhesive layer protecting film 440 and the polarizer protecting film 420 each includes polyethyleneterephthalate (PET) that has a glass transition temperature (Tg) of about 80° C. Moreover, the antistatic layer 450 is formed at a temperature of no more than about 80° C.

Referring to FIG. 8D, a polarizer protecting film 420 is attached to a surface of the polarizer 410. The adhesive layer 430 is on a side opposite to the polarizer protecting film 420. Alternatively, an antistatic film may be formed on the polarizer protecting film 420. The polarizer protecting film 420 may also be attached to the surface of the polarizer 410 before the formation of the antistatic layer 450.

In FIGS. 8A to 8D, the antistatic layer 450 is on the polarizer protecting film 420. Alternatively, in addition to the antistatic layer 450 already mentioned, the polarizer assembly may further include an additional antistatic layer between the polarizer 410 and the adhesive layer 430. That is, the additional antistatic layer may be formed before the formation of the adhesive layer 430. Alternatively, the polarizer 410 may include a plurality of conductive particles. In addition, the adhesive layer 430 may also include a plurality of conductive particles.

The polarizer protecting film 420 is on a surface of the polarizer 410 to protect the polarizer 410.

The adhesive layer 430 is on a side of the polarizer 410 opposite to the polarizer protecting film 420.

According to the polarizer assembly 400 shown in FIGS. 5 and 6, the antistatic layer 450 is on the adhesive layer protecting film 440 to absorb the electrostatic charge that is generated during the detaching of the adhesive layer protecting film 440 from the adhesive layer 430.

In addition, when the adhesive layer protecting film 440 is detached from the adhesive layer 430, the antistatic layer 450 is removed with the adhesive layer protecting film 440 so that the light transmittance of the polarizer assembly 400 is improved.

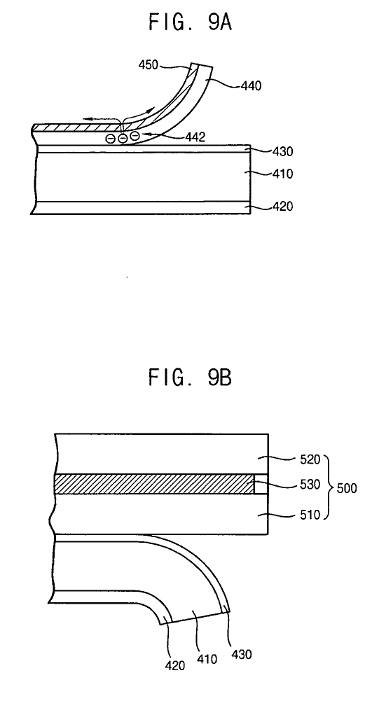

FIGS. 9A and 9B are cross-sectional views showing a method of manufacturing a panel assembly in accordance with an exemplary embodiment of the present invention.

Referring to FIG. 9A, an adhesive layer protecting film 440 having an antistatic layer 450 is removed from a polarizer assembly. The polarizer assembly includes a polarizer 410, a polarizer protecting film 420, an adhesive layer 430, an adhesive layer protecting film 440 and the antistatic layer 450.

The polarizer 410 polarizes an externally provided non-polarized light into a polarized light. That is, non-polarized light that vibrates in various directions is polarized by the polarizer 410 so that the polarized light vibrates in a polarization axis and then passes through the polarizer 410. The polarizer protecting film 420 is on one surface of the polarizer 410 to protect the polarizer 410. The adhesive layer 430 is on another surface of the polarizer 410. The adhesive layer protecting film 440 is on the adhesive layer 430 to protect the adhesive layer 430. The antistatic layer 450 is on the adhesive layer protecting film 440.

When the adhesive layer protecting film 440 having the antistatic layer 450 is detached from the polarizer assembly, an electrostatic charge 442 may be generated in the adhesive layer 430. The electrostatic charge 442 is absorbed in the antistatic layer 450 to be dispersed or discharged in substantially the entire antistatic layer 450.

Referring to FIGS. 9A and 9B, the polarizer assembly from which the adhesive layer protecting film 440 is removed is aligned on an LCD panel 500. The polarizer assembly may be aligned by a mechanical unit such as a zig.

The polarizer assembly from which the adhesive layer protecting film 440 is removed is attached on one surface of the LCD panel 500. That is, when the adhesive layer protecting film 440 is removed from the polarizer assembly, the adhesive layer 430 is exposed, and the exposed adhesive layer 430 is attached to the display panel 500.

At this point, the polarizer assembly no longer has the electrostatic charge 442 because as described above, this charge 442 has already been removed by the antistatic layer 450, and thus the electrostatic charge 442 is not applied to the LCD panel 500. The LCD panel 500 includes a first substrate 510, a second substrate 520 and a liquid crystal layer 530.

The first substrate 510 includes a plurality of pixel electrodes that are arranged in a matrix shape, a plurality of thin film transistors (TFT) and a plurality of signal lines. The thin film transistors apply driving voltages to the pixel electrodes, respectively. The signal lines are electrically connected to the thin film transistors to transmit electric signals.

The second substrate 520 corresponds to the first substrate 510. The second substrate 520 includes a common electrode and a plurality of color filters. The common electrode has a transparent conductive material. Moreover, the common electrode and the color filters correspond to the pixel electrodes.

The liquid crystal layer 530 is interposed between the first and second substrates 510 and 520. The liquid crystals of the liquid crystal layer 530 vary their arrangement in response to an electric field formed between the pixel electrodes and the common electrode. The above mentioned rearrangement of the liquid crystals in response to an electric field may also cause the light transmittance of the liquid crystal layer 530 to be changed, thereby resulting in an image being displayed.

In FIGS. 9A and 9B, the polarizer assembly from which the adhesive layer protecting film 440 is removed is attached to the first substrate 510 of the LCD panel. Alternatively, an additional polarizer assembly may also be attached to the second substrate 520.

The electrostatic charge 442 generated by detaching the adhesive layer protecting film 440 from the polarizer assembly is discharged by the antistatic layer 450 to protect the LCD panel 500.

In FIGS. 9A and 9B, the polarizer assembly includes the antistatic layer 450 on the polarizer protecting film 420. Alternatively, the polarizer assembly may include an additional antistatic layer between the polarizer 410 and the adhesive layer 430. A plurality of conductive particles may be incorporated in the polarizer 410 or the adhesive layer 430.

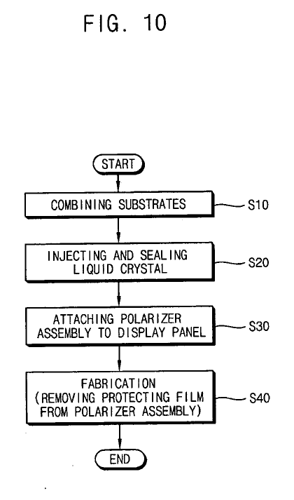

FIG. 10 is a flow chart showing a method of manufacturing a display device in accordance with an exemplary embodiment of the present invention.

Referring to FIG. 10, a common electrode and a pixel electrode are formed on an upper substrate and a lower substrate, respectively. The upper substrate is combined with the lower substrate (step S10). A liquid crystal is injected between the upper and lower substrates, and the liquid crystal is sealed to form a display panel (step S20). A polarizer assembly is attached to the display panel (step S30). In particular, an upper polarizer assembly and a lower polarizer assembly are attached to the upper and lower substrates, respectively. The display panel is then combined with a backlight assembly to complete the fabrication of the display device (step S40).

The polarizer assembly includes an adhesive layer protecting film or a polarizer protecting film that is antistatic treated. When the display device is fabricated, the adhesive layer protecting film or the polarizer protecting film is removed from the polarizer assembly.

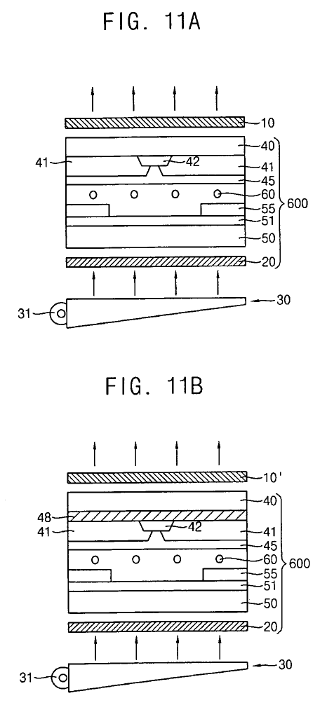

FIG. 11A is a cross-sectional view showing a display device manufactured by the method shown in FIG. 10.

Referring to FIG. 11A, the display device includes a display panel 600 and a backlight assembly 30. The display panel 600 includes an upper substrate 40 and a lower substrate 50. The backlight assembly 30 is located underneath the display panel 600. A liquid crystal 60 is interposed between the upper and lower substrates 40 and 50, and the liquid crystal 60 is sealed between the upper and lower substrates 40 and 50. An upper polarizer assembly 10 and a lower polarizer assembly 20 are attached to an upper surface and a lower surface of the display panel 600, respectively.

A lamp 31 of the backlight assembly 30 generates a light. The light generated from the lamp 31 passes through the lower polarizer assembly 20, the display panel 600 and the upper polarizer assembly 10. The upper substrate 40 includes a color filter 41, a black matrix 42 and a common electrode 45 that are formed thereon. The lower substrate 50 includes an insulating layer 51 and a pixel electrode 55 that are formed thereon. A reference voltage and a data voltage are applied to the common electrode 45 and the pixel electrode 55, respectively, to display an image. The light generated from the backlight assembly 30 passes through the upper and lower polarizer assemblies 10 and 20 so that the luminance of the image is changed by light transmittance of the upper and lower polarizer assemblies 10 and 20.

Each of the upper and lower polarizer assemblies of FIG. 11A is same as in FIGS. 1 to 10 to increase the luminance of the display device. Thus, any further explanation will be omitted. The adhesive layer protecting film or the polarizer protecting film that is antistatic treated may then be removed (step S40 in FIG. 10) to increase the luminance of the display device. When the display device is completed, an antistatic layer is no longer required.

FIG. 11B is a cross-sectional view showing an LCD device manufactured by a method in accordance with an exemplary embodiment of the present invention.

Referring to FIG. 11B, the LCD device includes a display panel 600, an upper polarizer assembly 10′, a lower polarizer assembly 20 and a backlight assembly 30. The display panel 600 includes an upper substrate 40 and a lower substrate 50. The lower polarizer assembly and the backlight assembly of FIG. 11B are same as in FIG. 11A. Thus, the same reference numerals will be used to refer to the same or like parts as those described in FIG. 11A and any further explanation will be omitted.

The lower polarizer assembly 20 of FIG. 11B is same as in FIGS. 1 to 10. However, the upper polarizer assembly 10′ of FIG. 11B is not antistatic treated. In FIG. 11B, the upper substrate 40 includes an antistatic member that is a transparent conductive layer 48. The upper substrate 40 includes a color filter 41, a black matrix 42, a common electrode 45 and a transparent conductive layer 48 that are formed thereon. The transparent conductive layer 48 is interposed between the upper substrate 40 and the color filter 41 to absorb an electrostatic charge so that the electrostatic charge is stored in the transparent conductive layer 48. That is, the transparent conductive layer 48 is an electrostatic screen. The light generated from the backlight assembly 30 may pass through the transparent conductive layer 48. Examples of the transparent conductive material that can be used for the transparent conductive layer 48 include but are not limited to indium tin oxide (ITO), or indium zinc oxide (IZO).

The transparent conductive layer 48 screens the electrostatic charge so that an antistatic layer of the upper polarizer assembly 10′ may be omitted. However, the lower polarizer assembly 20 includes the antistatic layer. The lower substrate 50 includes gate and data lines and a thin film transistor (TFT). The upper substrate 40 includes the color filter 41 that electrically insulates the transparent conductive layer 40 and the common electrode 45. However, when the lower substrate 50 does not include a thick insulating layer (for example, the color filter, or an organic layer), the transparent conductive layer is not formed on the lower substrate 50. Therefore, the lower polarizer assembly 20 requires the antistatic layer.

The transparent conductive layer 48 is formed on the upper substrate 40 to absorb an externally provided electrostatic charge that is generated after the completion of the LCD device. For example, when a user touches the LCD device, an electrostatic charge may be applied to the LCD device. That is, when the LCD device is completed, the externally provided electrostatic charge that is applied to an upper surface of the LCD device is discharged by the transparent conductive layer 48. An electrostatic charge that is generated during the manufacturing of the LCD device is applied to a lower surface of the LCD device so that the antistatic layer is not required after the completion of the LCD device.

According to exemplary embodiments of the present invention, an antistatic member such as for example, an antistatic layer absorbs electrostatic charges that are generated during the detaching of the adhesive layer protecting film from the polarizer assembly so that these electrostatic charges are not applied to the display device, thereby improving the image display quality of the display device.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A polarizer assembly comprising:
a polarizer;
an adhesive layer on the polarizer;
an adhesive layer protecting film that is attached to the adhesive layer; and
an antistatic member that absorbs an electrostatic charge generated during detachment of the adhesive layer protecting film from the adhesive layer.

2. The polarizer assembly of claim 1, wherein the antistatic member comprises a conductive layer on the adhesive layer protecting film.

3. The polarizer assembly of claim 1, wherein the antistatic member comprises a plurality of conductive particles in the polarizer.

4. The polarizer assembly of claim 1, wherein the antistatic member comprises a conductive material in the adhesive layer.

5. The polarizer assembly of claim 1, wherein the antistatic member comprises a conductive layer between the polarizer and the adhesive layer.

6. The polarizer assembly of claim 1, wherein a surface resistance of the antistatic member is no more than about 10⁸ Ω/sq.

7. The polarizer assembly of claim 5, wherein a thickness of the conductive layer is about 50 \acute{Å} to about 500 \acute{Å}.

8. The polarizer assembly of claim 1, further comprising a polarizer protecting film on the polarizer to protect the polarizer.

9. The polarizer assembly of claim 8, further comprising an antistatic layer on the polarizer protecting film to absorb an electrostatic charge that is generated during the detachment of the polarizer protecting film from the polarizer.

10. The polarizer assembly of claim 9, wherein the antistatic layer comprises a metal layer.

11. The polarizer assembly of claim 9, wherein a surface resistance of the antistatic layer is no more than about 10⁸ Ω/sq.

12. The polarizer assembly of claim 9, further comprising a surface treated layer between the polarizer and the polarizer protecting film to improve optical characteristics of the polarizer assembly.

13. The polarizer assembly of claim 1, wherein the polarizer further comprises:
a polarizing film;
an upper supporting film on an upper surface of the polarizing film to support the polarizing film; and
a lower supporting film on a lower surface of the polarizing film to support the polarizing film.

14. A method of manufacturing a polarizer assembly comprising:
forming a polarizer;
forming an adhesive layer on the polarizer;
forming an antistatic member operatively coupled to the polarizer; and
attaching an adhesive layer protecting film to the adhesive layer, wherein the antistatic member absorbs an electrostatic charge generated during detachment of the adhesive layer protecting film from the adhesive layer.

15. The method of claim 14, wherein the adhesive layer comprises a conductive material.

16. The method of claim 14, wherein the forming of the adhesive layer comprises:
forming a conductive layer on the polarizer; and
forming the adhesive layer on the conductive layer.

17. The method of claim 14, further comprising attaching a polarizer protecting film on the polarizer.

18. The method of claim 17, further comprising forming an antistatic layer on the polarizer protecting film.

19. The method of claim 14, wherein the antistatic member comprises a conductive layer on the adhesive layer protecting film.

20. The method of claim 14, wherein the antistatic member comprises a plurality of conductive particles in the polarizer.

21. The method of claim 14, wherein the antistatic member comprises a conductive material in the adhesive layer.

22. The method of claim 14, wherein the antistatic member comprises a conductive layer between the polarizer and the adhesive layer.

23. A method for forming a display panel assembly comprising:
providing a polarizer assembly comprising:
a polarizer;
an adhesive layer protecting film attached to the adhesive layer; and
an antistatic member that absorbs an electrostatic charge generated during detachment of the adhesive layer protecting film from the adhesive layer;
removing the adhesive layer protecting film from the polarizer assembly;
aligning the polarizer assembly without the adhesive layer protecting film on a display panel; and
attaching the polarizer assembly without the adhesive layer protecting film to the display panel.

24. The method of claim 23, further comprising forming a conductive layer on the adhesive layer protecting film.

25. The method of claim 23, wherein the polarizer assembly comprises a polarizer having a conductive material.

26. The method of claim 23, wherein the polarizer assembly without the adhesive layer protecting film is attached to the display panel through the adhesive layer.

27. The method of claim 23, wherein the adhesive layer comprises a conductive material therein.

28. The method of claim 23, further comprising forming a conductive layer between the polarizer and the adhesive layer.

29. The method of claim 23, further comprising removing a polarizer protecting film from the polarizer assembly.
